(19) United States
(12) Patent Application Publication
(10) Pub. No.: US 2012/0037377 A1
(43) Pub. Date: Feb. 16, 2012

(54) ALUMINUM AUXILIARY LINES FOR DRILLING RISER

(75) Inventor: Stephen John Walker, Houston, TX (US)

(73) Assignee: CAMERON INTERNATIONAL CORPORATION, Houston, TX (US)

(21) Appl. No.: 13/257,962

(22) PCT Filed: Apr. 22, 2010
(86) PCT No.: PCT/US2010/032129

§ 371 Date: Sep. 20, 2011

Related U.S. Application Data
(60) Provisional application No. 61/175,393, filed on May 4, 2009.

(51) Int. Cl. E21B 17/08; B23P 11/00; F16L 25/00

(52) U.S. Cl. 166/345; 285/333; 29/428

(57) ABSTRACT

A drilling riser joint is provided that may include one or more auxiliary lines (34) having aluminum tubes (48). The auxiliary line includes steel portions (50,52) at each end of the aluminum tube such that flanges of the drilling riser joint contact the steel portion. The aluminum tube and steel portion may be coupled together via box and pin fittings. Each end of the aluminum tube includes a threaded box and one end of each steel portion includes a threaded pin. The steel portions may also include additional box and pin fittings for coupling to adjacent auxiliary lines.

### CROSS REFERENCE TO RELATED APPLICATION

This application claims priority to U.S. Provisional Patent Application No. 61/175,393, entitled “Aluminum Auxiliary Lines for Drilling Riser”, filed on May 4, 2009, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

As will be appreciated, oil and natural gas have a profound effect on modern economies and societies. Indeed, devices and systems that depend on oil and natural gas are ubiquitous. For instance, oil and natural gas are used for fuel in a wide variety of vehicles, such as cars, airplanes, boats, and the like. Further, oil and natural gas are frequently used to heat homes during winter, to generate electricity, and to manufacture an astonishing array of everyday products.

In order to meet the demand for such natural resources, companies often invest significant amounts of time and money in searching for and extracting oil, natural gas, and other subterranean resources from the earth. Particularly, once a desired resource is discovered below the surface of the earth, drilling and production systems are often employed to access and extract the resource. These systems may be located onshore or offshore depending on the location of a desired resource. Further, such systems generally include a wellhead assembly through which the resource is extracted. These wellhead assemblies may include a wide variety of components, such as various casings, valves, fluid conduits, and the like, that control drilling and/or extraction operations.

To extract the resources from a well, a drilling riser may extend from the well to a rig. For example, in a subsea well, the drilling riser may extend from the seafloor up to a rig on the surface of the sea. A typical drilling riser may include a flanged assembly formed from steel, and the drilling riser may perform multiple functions. In addition to transporting drilling fluid into the well, the riser may provide pipes to allow drilling fluids, mud, and cuttings to flow up from the well.

As subsea wells are placed in deeper subsea locations (e.g., 10,000 to 12,000 ft.), conventional steel drilling risers may become difficult to install and operate. Because of the tension and pressure load at such depths, typical drilling riser joints are heavier to withstand this increased tension and pressure. However, such heavier drilling risers may exceed the derrick capacity of the rig supporting the riser. Additionally, longer drilling risers may require increased tension to ensure stability and rigidity of the riser. Further, assembly, replacement, and repair of such drilling risers may present challenges in these deeper subsea installations.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a block diagram of a mineral extraction system in accordance with an embodiment of the present invention;

FIG. 2 is a side view of a drilling riser joint having aluminum auxiliary lines in accordance with an embodiment of the present invention;

FIG. 3 is an end view of the drilling riser joint taken along line 2-2 in accordance with an embodiment of the present invention;

FIG. 4 is a cross-section of the drilling riser joint taken along line 3-3 of FIG. 2 in accordance with an embodiment of the present invention;

FIG. 5 is a cross-section of a region of the drilling riser joint of FIG. 4 in accordance with an embodiment of the present invention;

FIG. 6 is a cross-section of a region of the drilling riser joint of FIG. 4 in accordance with an embodiment of the present invention;

FIG. 7 illustrates assembly of the drilling riser joint of FIG. 2 in accordance with an embodiment of the present invention;

FIG. 8 is an alternate embodiment of a drilling riser in accordance with an embodiment of the present invention; and

FIG. 9 is an embodiment of a process for assembling a drilling riser joint and auxiliary line in accordance with an embodiment of the present invention.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

Embodiments of the present invention include aluminum and steel auxiliary lines for a drilling riser. In one embodiment, each joint of the drilling riser may include an auxiliary line having an aluminum tube axially disposed between a first steel portion and a second steel portion at opposite axial end portions. The drilling riser joints may be coupled together by steel flanges at opposite axial ends of the joint, such that only the first steel portion and the second steel portion of the auxiliary line extends though the steel flanges. The first and second steel portions at axial ends of the auxiliary line reduce or eliminate any contact between the aluminum tube and the steel flanges. Further, in some embodiments, the drilling riser joint may be assembled by inserting the aluminum tube radially or laterally between the first and second steel portions. Additionally, in some embodiments the drilling riser may be weighted at one end by including steel auxiliary lines along one section of the drilling riser and aluminum and steel auxiliary lines along another section of the drilling riser.

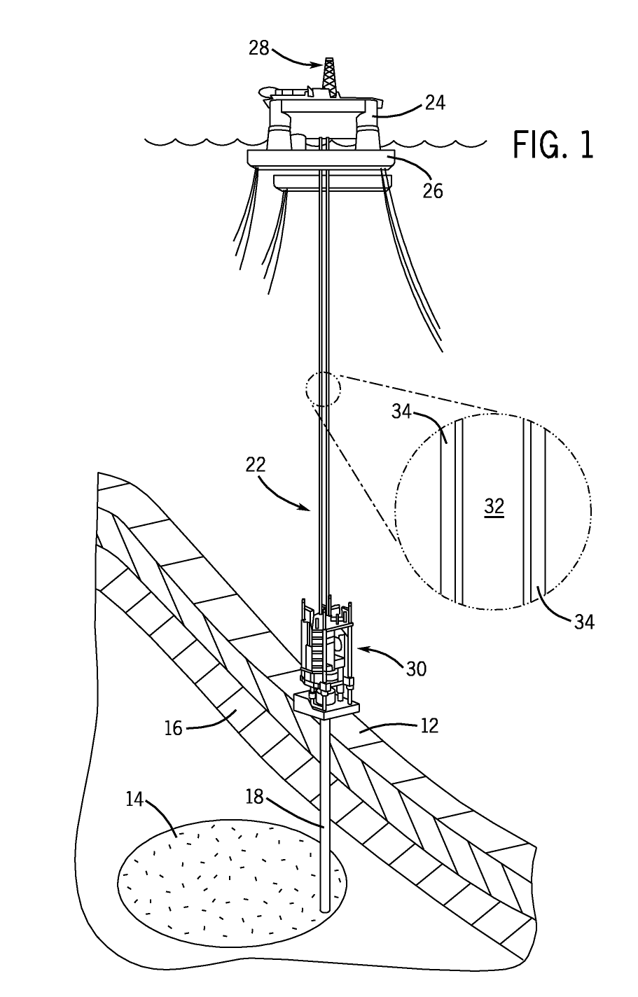

FIG. 1 is a block diagram that illustrates an embodiment of a subsea mineral extraction system 10. The illustrated mineral extraction system 10 can be configured to extract various minerals and natural resources, including hydrocarbons (e.g., oil and/or natural gas), or configured to inject substances into the earth. In some embodiments, the mineral extraction system 10 is land-based (e.g., a surface system) or subsea (e.g., a subsea system). As illustrated, the system 10 includes a wellhead 12 coupled to a mineral deposit 14 via a well 16, wherein the well 16 includes a well-bore 18.

The wellhead assembly 12 typically includes multiple components that control and regulate activities and conditions associated with the well 16. For example, the wellhead assembly 12 generally includes bodies, valves and seals that route produced minerals from the mineral deposit 14, provide for regulating pressure in the well 16, and provide for the injection of chemicals into the well-bore 18 (down-hole). In the illustrated embodiment, the wellhead 12 may include, a tubing spool, a casing spool, and a hanger (e.g., a tubing hanger or a casing hanger). The system 10 may include other devices that are coupled to the wellhead 12, such as a blowout preventer (BOP) stack 30 and devices that are used to assemble and control various components of the wellhead 12.

A drilling riser 22 may extend from the BOP stack 30 to a rig 24, such as a platform or floating vessel. The rig 24 may be positioned above the well 16. The rig 24 may include the components suitable for operation of the mineral extraction system 10, such as pumps, tanks, power equipment, and any other components. The rig 24 may include a derrick 28 to support the drilling riser 22 during running and retrieval, a tension control mechanism, and any other components.

The wellhead assembly may include a blowout preventer (BOP) 30. The BOP 30 may consist of a variety of valves, fittings and controls to block oil, gas, or other fluid from exiting the well in the event of an unintentional release of pressure or an overpressure condition. These valves, fittings, and controls may also be referred to as a “BOP stack.”

The drilling riser may carry drilling fluid (e.g., “mud) from the rig 24 to the well 16, and may carry the drilling fluid (“returns”), cuttings, or any other substance, from the well 16 to the rig 24. The drilling riser 22 may include a main line 32 having a large diameter and one or more auxiliary lines 34, as described further below. The main line 32 may be connected centrally over the bore (such as coaxially) of the well 16, and may provide a passage from the rig to the well. The auxiliary lines 34 may include choke lines, kill lines, hydraulic lines, glycol injection, mud return, and/or mud boost lines. For example, some of the auxiliary lines 34 may be coupled to the BOP 30 to provide choke and kill functions to the BOP 30.

As described further below, the drilling riser 22 may be formed from numerous “joints” of pipe, coupled together via flanges, or any other suitable devices. Additionally, the drilling riser may include flotation devices, clamps, or other devices distributed along the length of the drilling riser 22.

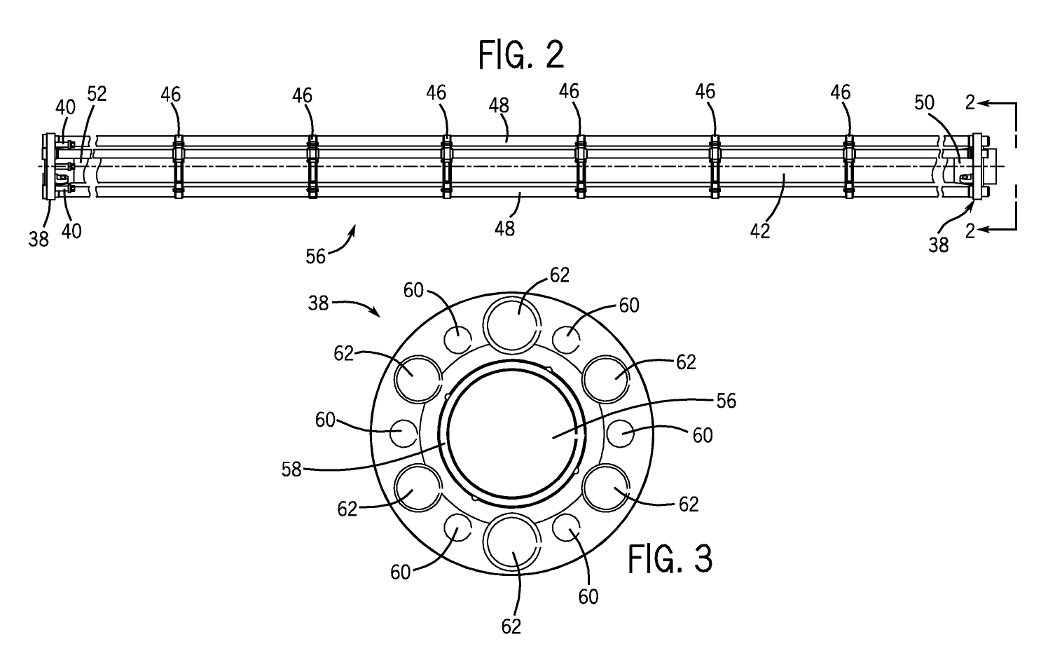

FIG. 2 depicts a side view of a drilling riser joint 36 of the drilling riser 22 in accordance with an embodiment of the present invention. The drilling riser joint 36 may include flanges 38 to couple the joint 36 to other joints and make-up the drilling riser 22. In this manner, a drilling riser 22 may be constructed to any desired length using a specific number of joints 36. The flanges 38 may include a plurality of bolts 40 to enable coupling to a flange of another joint of the riser 22.

As shown in the FIG. 2, the drilling riser joint 36 includes the main line 32 and auxiliary lines 34. The drilling riser joint 36 may include any number of auxiliary lines 34 surrounding the main line 32. In some embodiments, the main line 32 of the drilling riser joint 36 may be a relatively larger diameter than the auxiliary lines 34. The drilling riser joint 36 may also include one or more clamps 46 located axially at intervals along the length of the drilling riser joint 36. The clamps 46 may secure and stabilize the auxiliary lines 34 and/or the main line 32. As described above, during operation of the mineral extraction system 10, tools, drilling fluids (e.g., mud), or any other substance or device may be provided down the main line 32. Drilling fluid, cuttings, or any other material from the well 16 may return up the auxiliary lines 34.

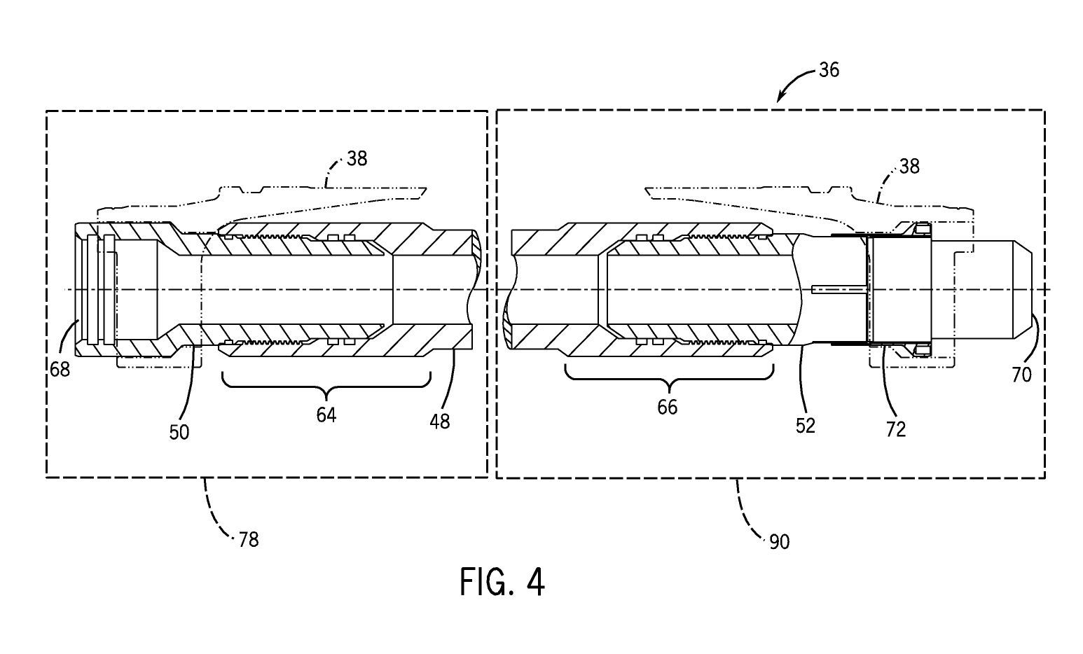

One or more of the auxiliary lines 34 may each include an aluminum tube 48 axially between a first steel portion 50 and a second steel portion 52 at opposite axial end positions. As described further below, the aluminum tube 48, a first steel portion 50, and a second steel portion 52 may be coupled together by pin and box fittings, as described below in FIG. 4. To couple segments of the auxiliary lines 34 together, the first steel portion 50 may be coupled to a steel portion of an adjacent auxiliary line of an adjacent riser joint. Similarly, the second steel portion 52 may be coupled to a steel portion of an adjacent auxiliary line of an adjacent riser joint. Thus, when assembling a plurality of drilling riser joints 36 together to form the drilling riser 22, the auxiliary lines 34 may be joined to form a continuous line along the length of the riser 22.

FIG. 3 is a front view of the drilling riser joint 36 taken along line 2-2 of FIG. 2 in accordance with an embodiment of the present invention. As shown in FIG. 3, the flange 38 includes a central bore 56 and may couple to the main line 32 (e.g., via welding the flange 38 and main line 32). The flange 38 may include an annular seal 58 to seal the flange 38 against an adjacent flange. Additionally, the flange 38 includes a plurality of receptacles 60 (e.g., threaded receptacles) configured to receive the plurality of bolts 40. To provide for assembly of the auxiliary lines 48, the flange 38 may include one or more holes 62 to allow for passage of the auxiliary lines 34 through the flange 38. For example, the flange 38 may include holes 62 for a choke line, a kill line, a mud boost line, a hydraulic line, etc. In some embodiments, the holes 62 may be of the same diameter or different diameters.

The aluminum tubes 48 of the auxiliary lines 34 aid in reducing the weight of the drilling riser joint 36. For example, in some embodiments, the weight of the drilling riser joint 36 may be reduced by at least 20%, 25%, 30%, etc. However, in embodiments using steel for the material of the flanges 38, it may be undesirable for the aluminum tubes 48 to remain in contact with the flanges 38, such as when the auxiliary line 34 is assembled into the drilling riser 22 and the auxiliary line 34 passes though the holes 62. Contact between the aluminum tube 48 and the steel flange 38 may result in galvanic corrosion between the two metals. Thus, to minimize or prevent corrosion, the steel portions 50 and 52 on either axial end of the auxiliary line 34 provide for steel-to-steel contact between the auxiliary line 34 and the flanges 38. Alternatively, in some embodiments the steel portions 50 and 52 may be replaced by aluminum portions and may be externally insulated from the steel flange 38.

FIG. 4 illustrates a cross-section of the drilling riser joint 36 taken along line 3-3 of FIG. 2 in accordance with an embodiment of the present invention. As discussed above and shown in FIG. 4, the auxiliary line 34 includes the aluminum tube 48 axially between the steel portion 50 and the steel portion 52. In the illustrated embodiment, the aluminum tube 48 may be coupled to the steel portions 50 and 52 by male and female fittings, such as box and pin fittings 64 and 66. Additionally, the steel portion 50 may include box fitting 68, and the steel portion 52 may include a pin fitting 70. The steel portion 52 may include an outer skirt 72 to couple the pin 70 to an adjacent steel portion. As described in further detail below, to assemble the auxiliary line 34, the steel portions 50 and 52 may be passed through the flange 38 and coupled to the aluminum tube 48 at opposite ends of the riser joint 36.

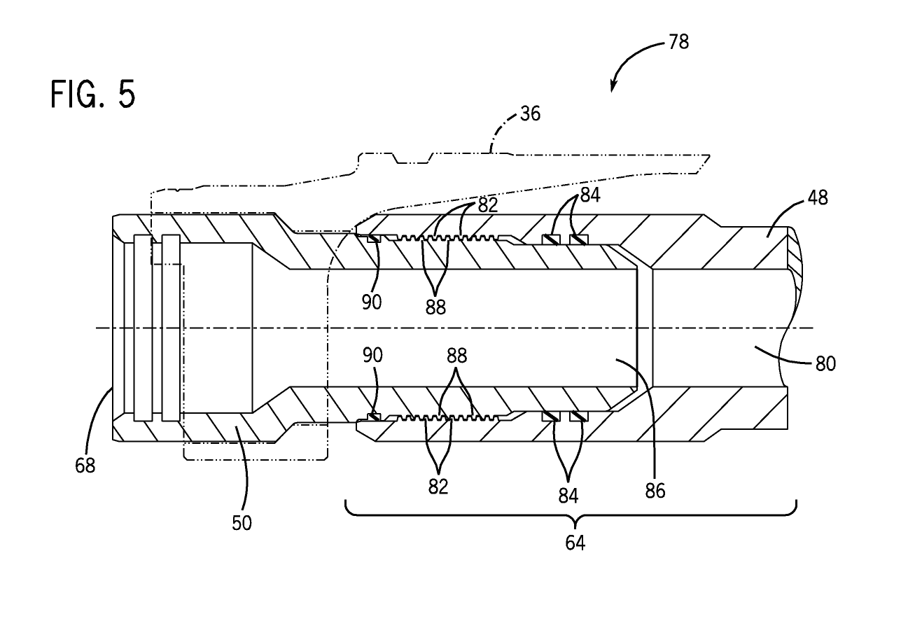

FIG. 5 is a close-up view of region 78 of FIG. 4, further illustrating the box and pin fitting 64 in further detail in accordance with an embodiment of the present invention. The aluminum tube 48 includes a female coupling or box 80 having threads 82 and annular seals 84. The seals 84 may include o-rings or any other suitable sealing device. The steel portion 50 includes a male coupling or pin end 86 having threads 88 and annular seals 90. The seals 90 may include o-rings or any other suitable sealing device. The pin end 86 is configured to extend coaxially into and engage the box 80 of the aluminum tube 48 via engagement of the threads 82 and 88. Thus, when assembling the auxiliary line 34, the pin end 86 of the steel portion 50 may be screwed into box 80 of the aluminum tube 48. The box 68 of the steel portion 50 enables coupling to a pin of a steel portion of an adjacent segment of the auxiliary line 34. For example, the pin end 70 of the steel portion 52 is illustrative of a steel portion that may be inserted into the box end 68 of the steel portion 50. In one embodiment, the pin end 70 of the steel portion 52 may include threads and the box end 68 of the steel portion 50 may include threads to enable the pin end 70 to couple to a correspondingly threaded box end (e.g., such as the box end 68).

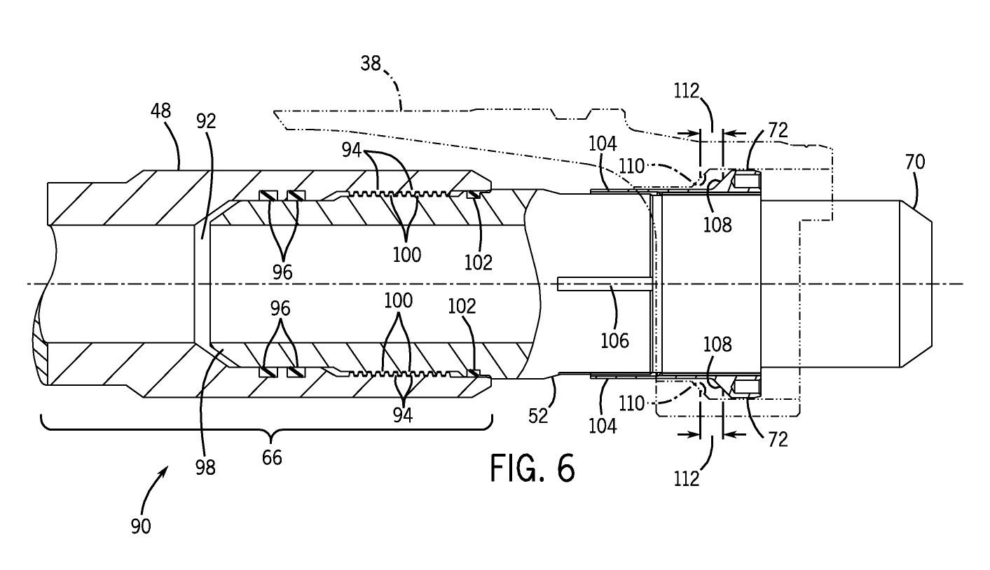

FIG. 6 is a close-up view of region 90 of FIG. 4, further illustrating the box and pin fitting 66 in further detail. Similar to FIG. 5 as discussed above, the box and pin fitting 66 includes a female coupling or box 92 of the aluminum tube 48 having threads 94 and annular seals 96. The seals 96 may include o-rings or any other suitable sealing devices. The steel portion 52 includes a male coupling or pin end 98 having threads 100 and annular seals 102. The seals 102 may include o-rings or any other suitable sealing device. As stated above, assembly of the auxiliary line 34 includes insertion of the pin end 98 coaxially into the box 92 of the aluminum tube 48 to engage the threads 94 and 100. The pin 70 of the steel portion 52 enables coupling to a box of a steel portion of an adjacent segment of the auxiliary line 34. For example, the box end 68 of the steel portion 52 is illustrative of a steel portion that may receive the pin 70 of the steel portion 52. In one embodiment, the pin end 70 of the steel portion 52 may include threads and the box end 68 of the steel portion 50 may include threads to enable the pin end 70 and box end 68.

The steel portion 52 includes a skirt 72 that may be used to obtain a desired axial distance between the flange 38 and the auxiliary line 34. The skirt 72 may include one or more tabs 104 that may engage one or more recesses 106 on the steel portion 52, securing the skirt 72 to the steel portion 52. The tabs 104 and recesses 106 are located at different angular positions about the circumference of the steel portion 52. The tabs 104 may be hammered or otherwise mechanically secured into the recesses 106. Additionally, the skirt 72 may include radial protrusions 108. The protrusions 108 aid in distributing the tension on the riser by abutting a beveled portion 110 of the flange 52. For example, the protrusions 108 may be placed at a specific axial distance 112 from the beveled portion 110 such that a specific amount of tension causes the specific distance 112 to decrease before the protrusions 108 engage the beveled portion 110 and cause tension to be translated to the auxiliary line 34. Additionally, the tension on the drilling riser 22 may be load shared across all the auxiliary lines 34 surrounding the main line 32 of the drilling riser 22.

The box and pin fittings 64 and 66 eliminate any aluminum-steel contact between the flange 38 and the aluminum tube 48, as only the steel portions 50 and 52 pass through the flange 38. The steel-to-steel contact in the flange 38 substantially or entirely prevents galvanic corrosion that may occur between aluminum and steel metal contact. Additionally, to prevent galvanic corrosion between the box 80 of the aluminum tube 48 and the pin end 86 of the steel portion 50 (FIG. 5), the threads 82 and 88 may include corrosion-resistant coatings. Similarly, to prevent galvanic corrosion between the box 92 of the aluminum tube 48 and the pin end 98 of the steel portion 52 (FIG. 6), the threads 94 and 100 may include similar corrosion-resistant coatings. In some embodiments, one or more sacrificial anodes may be provided to reduce or prevent any corrosion.

As described above, use of the aluminum tube 48 in the auxiliary line 34 reduces the weight of the drilling riser 22. Additionally, the pin and box fittings 62 and 66 and/or the aluminum tube 48 may be “field replaced. For example, the pin and box fittings 62 and 66 and aluminum tube 48 can be replaced in the field to repair or replace a joint of the drilling riser 22, as opposed to a conventional steel riser which requires cutting off and re-welding of the fittings to repair the riser 22. Further, because no welding is used on the auxiliary line 34, manufacturing time and cost may be reduced over conventional steel risers. Additionally, as discussed further below, the auxiliary line 34 may be retrofitted to existing drilling risers, such as drilling risers manufactured by Cameron, Inc.

Additionally, the reduced weight of the drilling riser 22 with the aluminum tube 48 also reduces the cost for buoyancy of the drilling riser 22. The increased buoyancy of the aluminum tube 48, and, thus, the assembled drilling riser 22, reduces the tension requirements. Accordingly, the drilling riser 22 with aluminum tube 48 reduces rig deck load, tension requirements, buoyancy requirements, derrick load, and associated costs.

It should be appreciated that other fitting configurations may be used to couple the steel portions 50 and 52 to the aluminum tube 48. In the embodiment discussed above, the aluminum tube 48 having the boxes 80 and 92 may be referred to as a “box-by-box” configuration. However, any other suitable configuration may be used, such as “pin-by-pin,” box and pin, etc. Similarly, although the illustrated steel portions 50 and 52 use a box and pin configuration to couple to an adjacent auxiliary line, other configurations may be used.

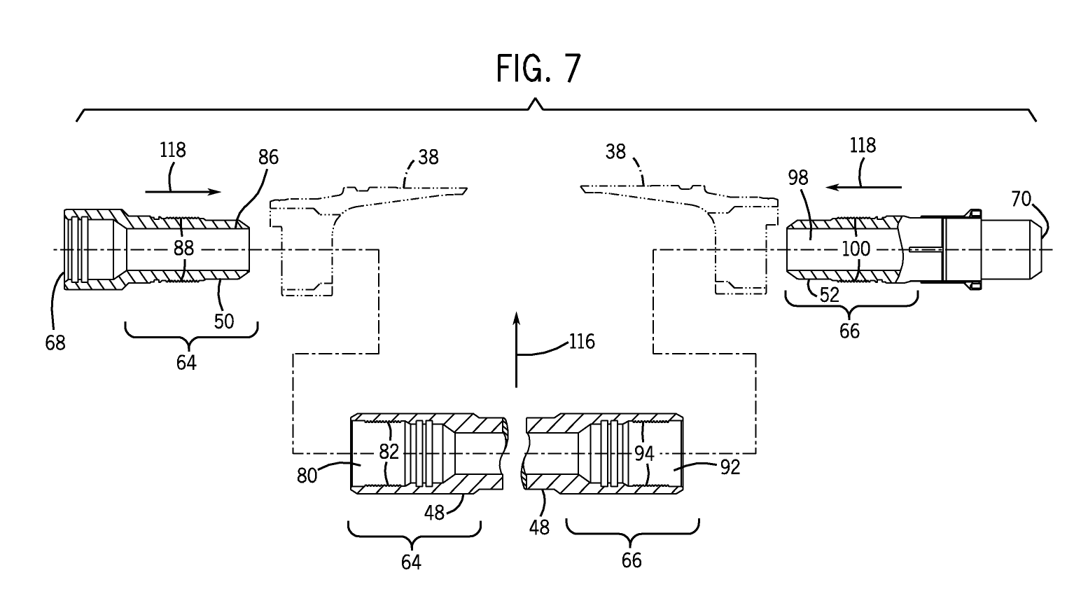

FIG. 7 is a cross-sectional view of the assembly of the drilling riser joint 36 with the aluminum tube 48 in accordance with an embodiment of the present invention. Using the pin and box fittings 64 and 66 described above, assembly of the auxiliary line 34 and drilling riser 22 may be simplified. It should be appreciated that the assembly may be accomplished by human operators and/or remotely operated vehicles (ROV's), and may include the use of any tools or devices that provide for easier manipulation of the various components. When assembling the auxiliary line 34, the aluminum tube 48 may be inserted radially or laterally between the flanges 38, as illustrated by arrow 116, instead of axially through the flanges 52. After insertion of the auxiliary line 34, the steel portion 50 may be inserted axially through the hole 62 of the flange 36, as shown by arrow 118. The pin end 86 may be rotated into the box 80 of the aluminum tube 48, engaging the threads 88 and 82. Similarly, the steel portion 52 may be inserted through a hole 62 of the flange 36, as indicated by arrow 120. The pin end 98 of the steel portion 52 may be rotated into engagement with the box 92 by engaging the threads 100 and 94.

Advantageously, the assembly of the aluminum tube 48 between the flanges 38 eliminates insertion of the entire assembled auxiliary line 34 axially through the flanges 38, reducing the difficulty and cost of assembly. Removal of the aluminum tube 48 and/or steel portions 50 and 52 may be accomplished in reverse of the manner described above. After assembly of a segment of the auxiliary line 34 into the drilling riser joint 32, the drilling riser joint 32 may be coupled to other drilling riser joints via the flanges 36 and bolts 40.

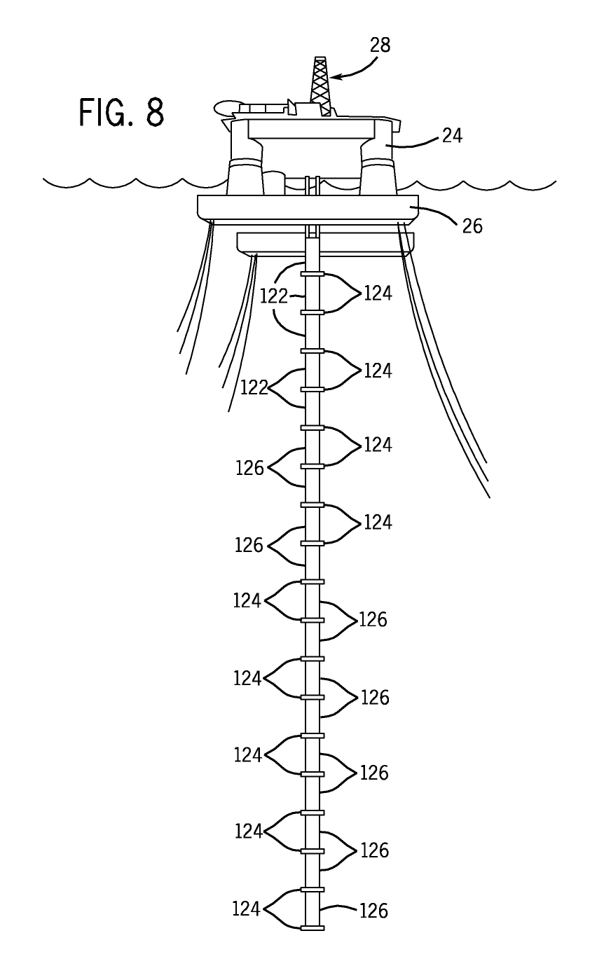

FIG. 8 depicts operation of a mineral extraction system 10 in accordance with another embodiment of the present invention. During operation of the mineral extraction system 10, it may be desirable to “hang-off” the drilling riser from the rig 24, such that the riser is not connected to the wellhead and is freely suspended. For example, a “hang-off” operation may be desirable during harsh weather conditions, so the vessel 26 can move away from the well and wait for the weather conditions to subside. To stabilize the drilling riser in a “hang-off” operation, it may be desirable for the drilling riser to be heavier near the bottom of the riser. Using the aluminum auxiliary lines 34 discussed above in some riser joints in combination with steel auxiliary lines in other riser joints, a weighted drilling riser may be constructed that has a weight distribution suited for a “hang-off” operation.

FIG. 8 depicts an embodiment of a drilling riser 120 having a first plurality of drilling riser joints 122 coupled together via flanges 124 and a second plurality of drilling joints 126 coupled together via flanges 124. The first plurality of drilling riser joints 122 may include auxiliary lines having aluminum tubes, such as described above in FIG. 3. Those auxiliary lines 122 having aluminum tubes may be located in the upper portions of the drilling riser 120. The second plurality of drilling riser joints 126 may include auxiliary lines having conventional steel tubing, such that these joints 126 are heavier than the first plurality of drilling riser joints 122.

As shown in FIG. 8, those drilling riser joints 126 having steel auxiliary lines may be located at the bottom of the assembled drilling riser 120, such that the lower portion of the drilling riser 120 is heavier than the upper portion that include aluminum auxiliary lines. In such an embodiment, there may be bare joints at the bottom of the drilling riser 120 that could be assembled with the steel auxiliary risers. In some embodiments there may be about eight to about twelve bare joints at the bottom of the drilling riser 120 that may be assembled with steel auxiliary lines.

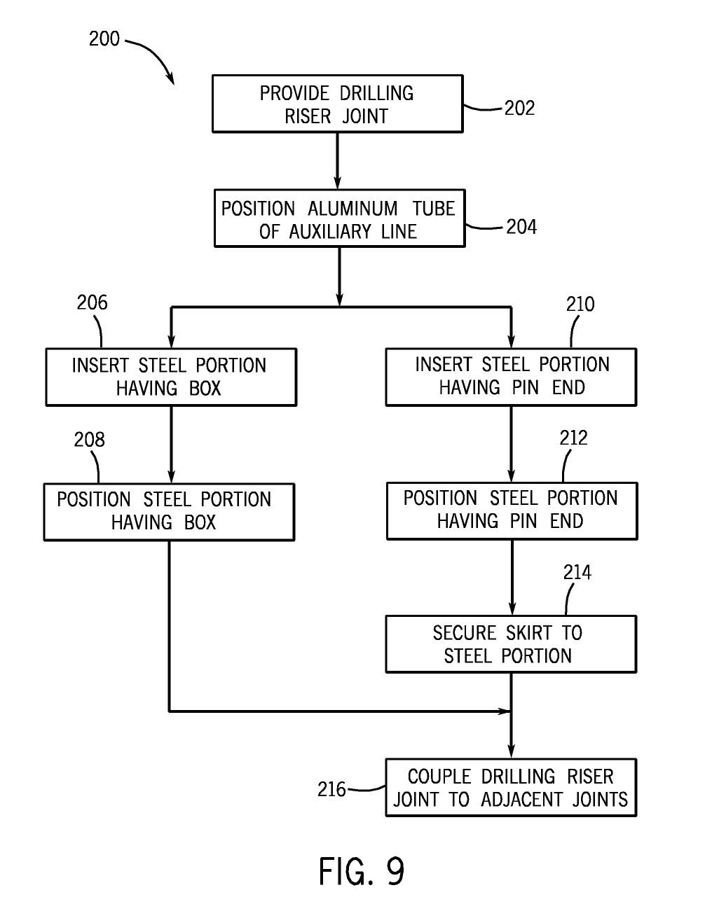

FIG. 9 depicts a process 200 for assembling the drilling riser in accordance with an embodiment of the present invention. Initially, the drilling riser joint 36 may be provided (block 202). To add the auxiliary line 34 to the drilling riser joint 36, the aluminum tube 48 of the auxiliary line 34 may be positioned axially between the flanges 38 of the joint 36 (block 204). As described above, the aluminum tube 48 may include box-by-box fittings, box-by-pin fittings, or pin-by-pin fittings. A first steel portion, such as the steel portion 50 having a box 68 as described above in FIGS. 4 and 5, may be inserted though the flange 38 and into an end of the aluminum tube 48 (block 206), such as into the box 80. The steel portion 50 may be screwed to the aluminum tube 48 via threads 82 and 88. The axial position of the steel portion 50 may be axially adjusted in the drilling riser joint 36 by adjusting the engagement of the threads 82 and 88 (block 208).

Similarly, the steel portion 52 having the pin 70 may be inserted through the flange 36 and into an end of the aluminum tube 48 (block 210), such as into the box 92. The steel portion 52 may be screwed into the aluminum tube 48 via threads 94 and 100. The axial position of the steel portion 52 may be adjusted by axially adjusting the engagement of the threads 94 and 100 (block 212). For example, in some embodiments, the steel portion 52 may be screwed into full engagement with the aluminum tube 48, and then “backed out” to provide the desired axial distance 112 between the protrusions 108 of the skirt 72 and the beveled edge 110 of the flange 38. As described above, the distance 112 can affect the amount of tension applied on the drilling riser 22 to translate the tension to the auxiliary line 34. After installing the steel portion 52, the skirt 72 may be secured in place by engaging the tabs 104 of the skirt 72 with the recesses 106 of the steel portion 52 (block 214). The drilling riser joint 36 may be coupled to one or more adjacent drilling riser joints via the flanges 38 and bolts 40. Further, in some embodiments, a drilling riser joint 34 may include both auxiliary lines formed entirely from steel and auxiliary lines having the aluminum tube and steel portions described above.

In some embodiments, installation and/or replacement of the steel portion 50 having the box 68 and the steel portion 52 having the pin 70 may be installed and/or replaced on the rig 24. The steel portion 50 may be unscrewed from the female end 80 (e.g., box) of the aluminum tube 48, and a new steel portion having a box may be inserted into the female end 80 (e.g., box) of the aluminum tube 48 via threads 82. Similarly, the steel portion 52 may be unscrewed from the female end 92 of the aluminum tube 48, and a new steel portion having a pin may be inserted into the female end 92 of the aluminum tube 48. In this manner, the pin 70 and/or box 68 of a section of auxiliary line 34 may be replaced in the field, e.g., on the rig 24, without removing the joint 36 from the rig 24 and sending to a remote location for disassembly and replacement (such as by welding).

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A component for a mineral extraction system, comprising:
a joint of a drilling riser, comprising:
an auxiliary line, comprising:
an aluminum tube;
a first steel portion coupled to a first end of the aluminum tube; and
a second steel portion coupled to a second end of the aluminum tube.

2. The component of claim 1, wherein the joint comprises one or more flanges, wherein the flanges comprise a plurality of threaded receptacles configured to receive a plurality of fasteners, and the one or more flanges comprise one or more holes configured to receive the auxiliary line.

3. (canceled)

4. The component of claim 1, wherein the first end comprises a first threaded receptacle configured to receive the first steel portion, and the second end comprises a second threaded receptacle configured to receive the second steel portion.

5. (canceled)

6. The component of claim 4, wherein the first and second threaded receptacles each comprise one or more annular seals.

7. The component of claim 4, wherein the first steel portion comprises a first threaded pin configured to couple with the first threaded receptacle.

8. The component of claim 7, wherein the second steel portion comprises a second threaded pin configured to couple with the second threaded receptacle.

9. The component of claim 1, wherein the first steel portion comprises a third receptacle configured to receive a second auxiliary line, and the second steel portion comprises a third protrusion configured to receive a third auxiliary line.

10. (canceled)

11. The component of claim 1, wherein the second steel portion comprises a skirt configured to engage the flange.

12. The component of claim 1, wherein the joint comprises a main line centrally disposed in the joint.

13. A mineral extraction system, comprising:
a wellhead;
a drilling riser coupled to the wellhead, comprising:
a main line;
one or more auxiliary lines, wherein at least one of the one or more auxiliary lines comprises:
an aluminum tube;
a first steel portion coupled to a first end of the aluminum tube; and
a second steel portion coupled to a second end of the aluminum tube.

14. The mineral extraction system of claim 13, comprising a derrick coupled to the drilling riser, a rig coupled to the derrick, or a combination thereof.

15. (canceled)

16. The component of claim 13, wherein the first end comprises a first threaded coupling configured to receive the first steel portion, and the second end comprises a second threaded coupling configured to receive the second steel portion.

17. The component of claim 13, wherein the first and second steel flanges are configured to couple with first and second steel portions.

18. The component of claim 13, comprising a plurality of auxiliary lines disposed at different angular positions about the circumference of the main line.

19. The component of claim 13, wherein the drilling riser is coupled to a tension controlling mechanism.

20. A method of assembling a mineral extraction system, comprising:
positioning an aluminum tube of an auxiliary line in a joint of a drilling riser;
inserting a first steel portion of the auxiliary line into a first end of the aluminum tube; and
inserting a second steel portion of the auxiliary line into a second end of the aluminum tube.

21. The method of claim 20, wherein inserting the first steel portion of the auxiliary line into the first end of the aluminum tube comprises engaging a first threaded pin of the first steel portion with a first threaded receptacle of the first end of the aluminum tube.

22. The method of claim 20, wherein inserting the second steel portion of the auxiliary line into the second end of the aluminum tube comprises engaging a second threaded pin of the second steel portion with a second threaded receptacle of the second end of the aluminum tube.

23. The method of claim 20, comprising positioning the second steel portion to create a distance between a flange of the joint and a skirt of the second steel portion, such that tension applied to the drilling riser moves the drilling riser over all or a portion of the distance.

24. The method of claim 20, comprising coupling the joint of the drilling riser to a second joint of the drilling riser.

25. (canceled)

26. A mineral extraction system, comprising:
a wellhead;
a rig;
a drilling riser coupled to the wellhead and the rig, comprising:
a main line;
a plurality of auxiliary lines disposed at different angular positions around the circumference of the main line, wherein one or more of the plurality of auxiliary lines comprises:
an aluminum tube;
a first steel portion coupled to a first end of the aluminum tube; and
a second steel portion coupled to a second end of the aluminum tube, wherein the aluminum tube is axially disposed between the first steel portion and the second steel portion;
a plurality of steel flanges disposed along a plurality of joints of the drilling riser, wherein each of the plurality of steel portions receive the first steel portion and the second steel portion.
